(19) United States
(12) Patent Application Publication
(10) Pub. No.: US 2002/0030734 A1
(43) Pub. Date: Mar. 14, 2002

(54) Coordinated audio/ visual omnidirectional recording

(76) Inventor: Robert S. Smith, San Jose, CA (US)

Correspondence Address: Robert Samuel Smith, 1263 EMORY STREET, SAN JOSE, CA, 95126, US

(21) Appl. No.: 09/955,013

(22) Filed: Sep. 10, 2001

Related U.S. Application Data
(60) Provisional application No. 60/231,513, filed on Sep. 9, 2000.

(51) Int. Cl. H04N 7/00

(52) U.S. Cl. 348/36; 348/164; 709/204; 348/14.01

(57) ABSTRACT

A system for presenting scenes selected from image signals generated by a camera having a 360° field of view. An array of transmitters, is located in the field of view. When a sound originates from a refion close to any one of the transmitters, the transmitter is actuated to transmit an address signal to a receiver located with the camera. The camera is equipped to select for presentation the scene corresponding to the transmitted address.

### CROSS REFERENCE TO EARLIER FILED APPLICATIONS

This application is a non-provisional application of provisional application No. 60/231,513 filed Sep. 9, 2000 from shich priority is claimed.

### FIELD OF THE INVENTION

This invention relates to simultaneous recording of panoramic visual data and panoramic audio dat and the application of the directed audio (or radiated) signal to focus the visual recording on the source of the directed audio signal particularly as it applies to a teleconferencing situation.

### BACKGROUND AND INFORMATION DISCLOSURE

The use of video photography has evolved steadily over the past forty years in its application to surveillance situations and environments. Applications include stationary systems such as are found in commercial establishments, and on moving bases such as robots, on submarines, vehicles, etc.

For example, U.S. Pat. No. 6,016,385 to Yee et al discloses a real time remotely controlled robot having a head with a pair of television cameras (eyes) and a pair of microphones (ears) and a pair of arms mounted on a mobile trunk. an operated located at a command center receives audio and visual signals from the robot and, in response, issued commands that control movement of the trunk and arms to perform tasks.

U.S. Pat. No. 4,453,085 to Pryor discloses an electro-optical system for monitoring the positioning of a movable arm.

U.S. Pat. No. 4,604,559 To Hawkes et al discloses a robot controlled by a user wherein an audio signal is fed back from the robot to the user regarding force and movement parameters of the robot operation.

U.S. Pat. No. 5,299,288 to Glassman et al discloses an image directed robot system for surgical applications including an optical tracking camera supplying data to the controlling processor.

One of the major developments in video photography in recent years has been the panoranic camera. According to this technology a lens with a 360° field of view stores the entire field in memory and various areas are selected and projected according to the interests of the viewer. This technique has many applications, for example, in real estate advertisements where features of the location are selected and enlarged for detailed examination by the viewer.

U.S. Pat. No. 5,920,337 to Glassman et al discloses an omnidirectional visual image detector and processor (incorporation herein by reference). There is described a reflective round lens (either a cone or spherical section) which reflects the object beam from a surrounding view (encircling the lens) to a direction parallel to the axis of the rotund lens. The beam then passes through an objective lens and is focussed onto a CCD (charge coupled device) where image data is detected and processed for storage or image presentation on a monitor.

In the context of this specification, the term, “visually examine” means that, a narrow field of view is selected covering a few degrees from an entire 360° field of view recorded by a panoramic video camera.

Meetings of groups of people for verbal exchange of information, etc., is an important activity in current business practice, in entertainment (talk shows), seminars, etc. The ideal arrangements for such gatherings is to have the attendees sitting around a conference table. Not only does the conference table geerate an intimate atmosphere, but the table is a common surface where the attendees can spread various documents which are the subject of the discussion. Many of these meetings are televised. The task of setting up unidirectional cameras at the right location and, when more than one camera is used, to switch back and forth between cameras as first one attendee then another, etc., speaks.

### SUMMARY

This invention is a system for presenting selected scenes from a video camera having a 360° field of view wherein the xcenes are selected by sounds such as a voice originating at the scene.

### BRIEF DESCRIPTION OF THE DRAWINGS

FIG. 1 shows a teleconferencing system characterizedas close proximity of attendees.

FIG. 2 shows a teleconferencing system which is voice controlled.

FIG. 3 shows a teleconferencing system which is controlled. by a moderator.

FIG. 4 shows a teleconfering system where the televiewing follows an object.

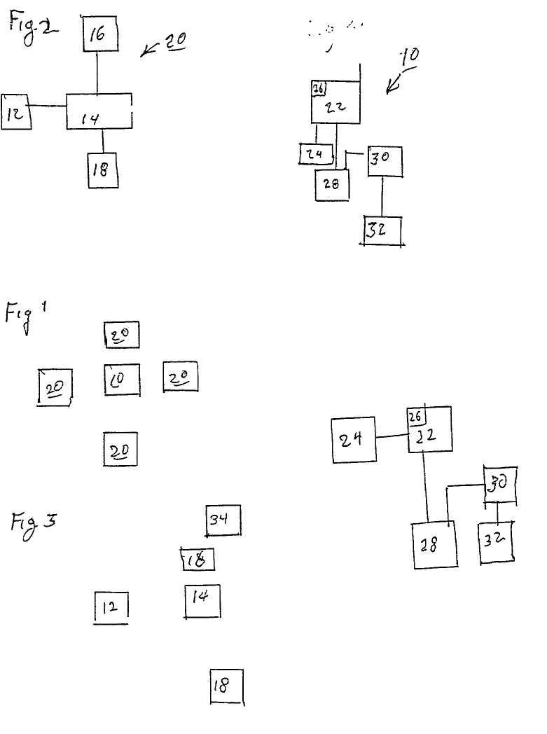

FIG. 1 shows this invention directed toward a teleconferencing system having a omnidirectional video camera station 10 in a central location arranged to communicate by infra red radiation with any selectable transmitter station 20(conference attendees) which is one an array of transmitter stations 20 arranged around the camera station 10.

FIG. 2 shows one transmitter station 20 including a microphone 12, a signal generator 14 coupled to a memory address 16. The generator 14 generates a carrier signal modulated by the transmitter address. The transmitter station 20 also has an IR transmitter 18 for broadcasting the address modulated signal to the camera station. The camera station 10 has an omnidirectional video camera 22. and IR receiver 24 for receiving the IR carrier signal from the transmitter station 20. The users voice is transmitted as a voice signal sent directly to the omnidirectional camera 22 where it is recorded by an audio detector 26 part of the camera 22. The IR address signal is transmitted to the camera providing that the camera 22 is notified as to the address of the speaker. The camera 22 locates and records the address as part of the video signal and stores the video recording in the video memory 28. A video controller 30 residing with the camera 22 displays that section of the panoramic view on monitor 32 which represents the origin of the audio signal. When the video recording is displayed on monitor 32, the video controller 30 reading the instant address on the video recording, displays the scene corresponding to the recorded address.

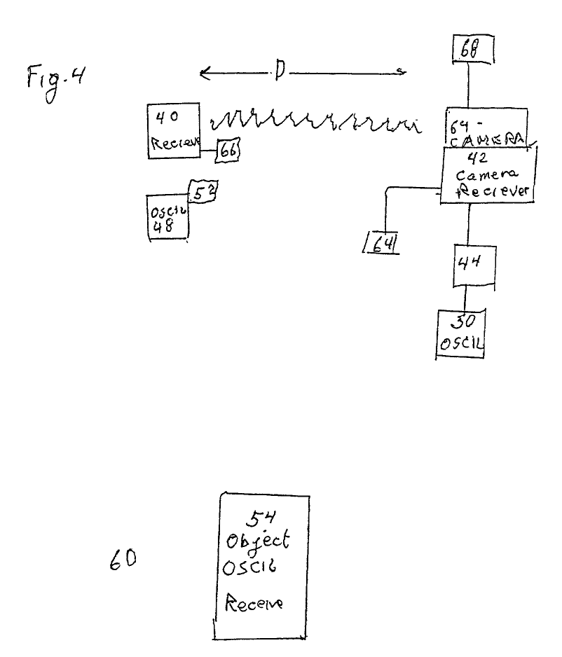

FIG. 3 shows another embodiment wherein the address signal is generated by a host moderator who has an address selector 34 with a list of the addresses of all the transmitter stations 20 so that he can select the address of the speaker or any other member of the audience according to his desire by operating the keyboard of his address selector. 34.

In a playback mode, the address selector is s the recording is being played back by the viewer who can press the button corresponding to an attendee to study the reaction of various attendees to the words of the speaking attendee.

In another embodiment, where the group is very large, so that direct transmission of the audio signal by air coupling is impractical, the voice signal modulates an IR carrier signal directed to a receiver at the camera. The carrier signal is also modulated by the unique address of the local transmitter. The address modulation is a high frequency (higher than the audio range) of the carrier so that the high frequency address signal can be separated from the low frequency audio signal after detection by the IR receiver by a high band pass filter in parallel with a low bandpass filter.

FIG. 4 shows still another embodiment which applies to a situation where it is required to maintain automatic surveillance of an object 46 (person, dog, ship, one or more athletes engaged in a team sport).

A central receiving system has a remote receiver 40 spaced from a camera receiver 42 located with camera 44 at a known distance D. The accuracy of the system is increased in proportion to the distance between the remote receiver 40 and the camera receiver 42.

A remote oscillator 48 and camera oscillator 50 each generate a carrier signal f. The remote receiver 40 receives the carrier signal from the camera oscillator 50 with which it is synchronized using a phase locked loop 52. The object has an oscillator 54 oscillating at the carrier frequency f. The object oscillator 54 is synchronized with the camera carrier signal when the object is at a ‘zero’ position proximal to the camera oscillator. Initialization is done with a phase locked loop located with the object. The object oscillator 54 broadcasts the carrier signal back to a camera receiver 42 and a remote receiver 40. When the object 60 is displaced from both the camera receiver 42 and the remote receiver 40, a phase detector 64 located with the camera and another phase detector 66 located with the remote station measure the phase shift of the signal received from the object with respect to the signals generated by the camera oscillator and the remote oscillator. respectively. Computer 68 is programmed to calculate the distances from the object to the camera and remote receiver from the respective phase shifts. The distance calculations are used together with the distance D between camera 64 and remote station to calculate the direction from the camera to the object. so that a final direction signal is obtained. The direction signal is the direction of the object relative to the camera. and is stored with the rest of the video data

I claim:

1. A system for coordinating video images being a part of a panoramic field of view with an audio signal generated from the part of the field of view which comprises:
a video camera having a panoramic lens for receiving video signals representing a surrounding 360° field of view;
display means coupled to said video camera for displaying scenes of said field of view selected from said video signal;
a first receiver coupled to said display means for receiving a carrier signal modulated with an address corresponding to said scene selected from said video signal; and
at least one transmitting station located at respective locations, each transmitting station including:
an address memory:
a first carrier signal generator for generating an address modulated carrier signal and coupled to said address memory;
a transmitter for broadcasting said address modulated carrier signal to said receiver station;
a microphone coupled to said first carrier signal generator arranged to activate said first carrier signal generator in response to said audio signal received by said microphone whereby said display means displays a scene from said field of view corresponding to said address in reponse to said audio signal generated at said address.

2. The system of claim 1 wherein said signal is an IR signal.

3. The system of claim 1 wherein:
said micorphone is arranged to modulate said carrier signal with said audio signal;
a detector coupled to said first receiver for detecting said audio signal from said carrier signal;
a speaker coupled to said detector for regenerating sound that produced said audio signal.

4. The system of claim 1 comprising:
said microphone aranged to modulate said carrier signal with said audio signal;
a detctor coupled to said first receiver arranged to detect said audio signal from said carrier signal;

5. The system of claim 1 comprising
a recorder arranged for recording said video signals on a recording medium and arranged for recording at a location on said recording medium corresponding to said location of said transmitting station, said audio signal originating from said transmitting station.
means for selecting from said recording medium for display on said display means and regeneration of sound a portion of said video and associated audio signal corresponding to an address stored with said video signal selected by a user.

6. The system of claim 1 comprising:
a second carrier frequency generator coupled to said receiver;
A phase detector arranged for detecting a phase difference between said first and second carrier signal generators;
a phase locked loop arranged for synchronizing a phases of carrier signals fro said first and second carrier frequncy generators when said receiver is proximal to said transmitter;
computer means for calculating a distance between said transmitter and receiver as a function of phase difference between a carrier signal frequency generated by said second carrier freuency generator and said carrier signal received by said receiver from said first carrier dignal after said first carrier signal generator is displaced by said distance from said second carrier signal generator
